(19) United States
(12) Patent Application Publication
(10) Pub. No.: US 2022/0229944 A1
(43) Pub. Date: Jul. 21, 2022

(54) SELECTIVE LOADING OF INTERACTION DATA FOR VISUALIZED ELEMENTS OF A COMPUTER-AIDED DESIGN (CAD) MODEL

(71) Applicant: Siemens Industry Software Inc., Plano, TX (US)

(72) Inventor: Derek Muktarian, MIlford, OH (US)

(21) Appl. No.: 17/609,301

(22) PCT Filed: May 22, 2019
(86) PCT No.: PCT/US2019/033522

§ 371 Date: Nov. 5, 2021

(51) Int. Cl. G06F 30/12

(52) U.S. Cl. CPC G06F 30/12; G06F 2111/02

(57) ABSTRACT

A client computing system may include a model visualization engine and a model interaction engine. The model visualization system may be configured to access, from a server computing system remote to the client computing system, visualization data to display a computer-aided design (CAD) model in a viewing window of the client computing system. The model interaction engine may be configured to query the server computing system for interaction data of a selected portion of the CAD model, but not other portions of the CAD model, wherein the interaction data comprises CAD model data that supports user interaction with the selected portion of the CAD model.

### BACKGROUND

Computer systems can be used to create, use, and manage data for products and other items. Examples of computer systems include computer-aided design (CAD) systems (which may include computer-aided engineering (CAE) systems), visualization and manufacturing systems, product data management (PDM) systems, product lifecycle management (PLM) systems, and more. These systems may include components that facilitate the design and simulated testing of product structures and product manufacture.

### BRIEF DESCRIPTION OF THE DRAWINGS

Certain examples are described in the following detailed description and in reference to the drawings.

FIG. 1 shows an example of a client computing system that supports selective loading of interaction data for visualized elements of a CAD model.

FIG. 2 shows an example architecture that supports selective loading of interaction data for visualized elements of a CAD model.

FIG. 3 shows an example of candidate CAD faces that a model interaction engine may identify to support selective loading of interaction data.

FIG. 4 shows an example of proximate CAD faces that a model interaction engine may identify to support selective loading of interaction data.

FIG. 5 shows an example of logic that a system may implement to support selective loading of interaction data for elements of a CAD model.

FIG. 6 shows an example of a system that supports selective loading of interaction data for elements of a CAD model.

### DETAILED DESCRIPTION

CAD systems and applications can be implemented in various ways. For instance, CAD applications may be offered as a cloud-based service, e.g., as a Software-as-a-Service (“SaaS”) offering in which client computing systems access centrally hosted CAD applications via locally implemented thin clients. In such client-server models, user access to CAD models may be a time-consuming and resource-consuming process, especially as CAD models continue to increase in size and complexity. Receiving and loading 3D CAD models from a server via thin clients may consume significant computing and network resources. In some cases, CAD systems can reduce (e.g., minimize) transmitted CAD model data to only what is required to visualize (e.g., display) a CAD model on a client computing system. As used herein, visualization data may refer to any CAD model data required by a client computing system to visualize a given CAD model.

Aside from visualization data, CAD applications may utilize other types of CAD model data to support various CAD functions and features, including CAD capabilities to interact with specific elements of a CAD model. Example interactions that a CAD application may support include CAD model element selection, dragging, context menu displays, heads-up displays, geometry analyses, and many other forms of interaction with CAD model elements. CAD model data used to support such interactions through a CAD application may be referred to as interaction data. In that regard, interaction data may include any CAD model data that supports user interaction with visualized CAD model elements of a CAD model. As used herein, interaction data and visualization data may be distinct, as visualization data allows a CAD system to visualize a CAD model whereas interaction data may support user interaction with different CAD model elements visualized via the CAD system.

Loading interaction data in SaaS-based CAD systems may incur additional resource, latency, and network consumption penalties. In some instances, interaction data may comprise a non-trivial amount of CAD model data needed to properly support CAD-based functionalities of CAD systems, as much as 30% of loaded CAD model data and at times more. Loading interaction data together with visualization data during initial model loading is one approach, but will incur additional latency and performance penalties to completely load a CAD model with the added interaction data upon user login to a CAD application. Another simplistic approach is to load interaction data for specific CAD model elements at the time of user interaction (e.g., at the time of a mouseover or mouse click over a given CAD model element). However, such approaches may incur lag and latency at the time such interactions occur to complete server queries for interaction data, and CAD application users may experience a noticeable delay when selecting or otherwise interacting with CAD model elements.

The disclosure herein may provide systems, methods, devices, and logic for selective loading of interaction data for visualized elements of a CAD model. As described in greater detail below, the selective interaction data loading features herein may support determination of candidate CAD faces visualized by a client computing system that a user may potentially interact with. In doing so, selective interaction data loading may leverage the idea that not all geometric elements of a given CAD model are realistic interaction candidates, including CAD model elements not even displayed in a current view or visualized CAD model elements that are too small for a user to realistically select.

Loading interaction data for all CAD model elements of a CAD model would result in wasted network bandwidth and resource consumption. As such, the features described herein may support culling of non-candidate CAD model elements as well as server queries for interaction data of determined interaction candidates without (unnecessarily) querying for interaction data of non-candidate CAD model elements. By doing so, the features described herein may selectively load interaction data for a candidate subset of geometric entities in a given CAD model (as low as 10% or lower), which may result in a reduction in data to query, download, and locally store as compared to other simplistic interaction data loading techniques.

These and other selective interaction data loading features and benefits are described in greater detail herein.

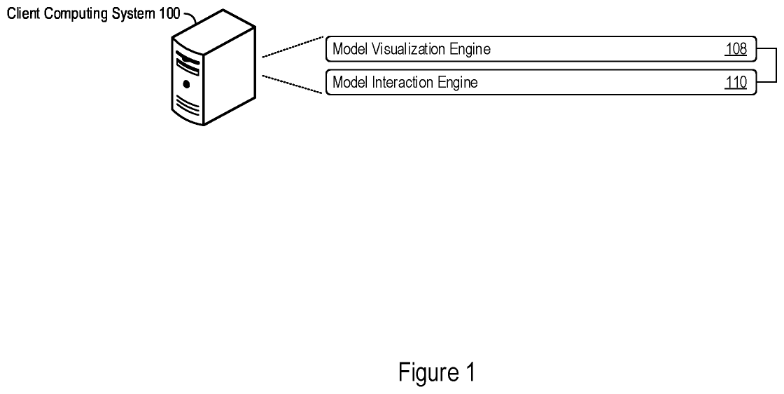

FIG. 1 shows an example of a client computing system 100 that supports selective loading of interaction data for visualized elements of a CAD model. The client computing system 100 may take the form of a single or multiple computing devices such as application servers, compute nodes, desktop or laptop computers, smart phones or other mobile devices, tablet devices, embedded controllers, and more. In some examples, the client computing system 100 implements or executes a thin client of a CAD application, providing access to cloud-based implementations of CAD applications. The client computing system 100 may interact with a server computing system at which CAD model data is centrally stored, acting as a client in a client-server architecture to access to CAD applications, CAD models, and various CAD functionalities.

As an example implementation to support any combination of the selective interaction data loading features described herein, the client computing system 100 shown in FIG. 1 includes an model visualization engine 108 and a model interaction engine 110. The client computing system 100 may implement the engines 108 and 110 (including components thereof) in various ways, for example as hardware and programming. The programming for the engines 108 and 110 may take the form of processor-executable instructions stored on a non-transitory machine-readable storage medium and the hardware for the engines 108 and 110 may include a processor to execute those instructions. A processor may take the form of single processor or multi-processor systems, and in some examples, the client computing system 100 implements multiple engines using the same computing system features or hardware components (e.g., a common processor or a common storage medium).

In operation, the model visualization engine 108 may access, from a server computing system remote to the client computing system 100, visualization data to display a CAD model in a viewing window of the client computing system. In operation, the model interaction engine 110 may query the server computing system for interaction data of a selected portion of the CAD model, but not other portions of the CAD model, wherein the interaction data comprises CAD model data that supports user interaction with the selected portion the CAD model. The selected portion of the CAD model determined by the model interaction engine 110 may include determined candidate CAD model elements that a user may potentially interact with, determined according to various interaction criteria as described in greater detail herein. These and other selective interaction data loading features according to the present disclosure are described in greater detail next.

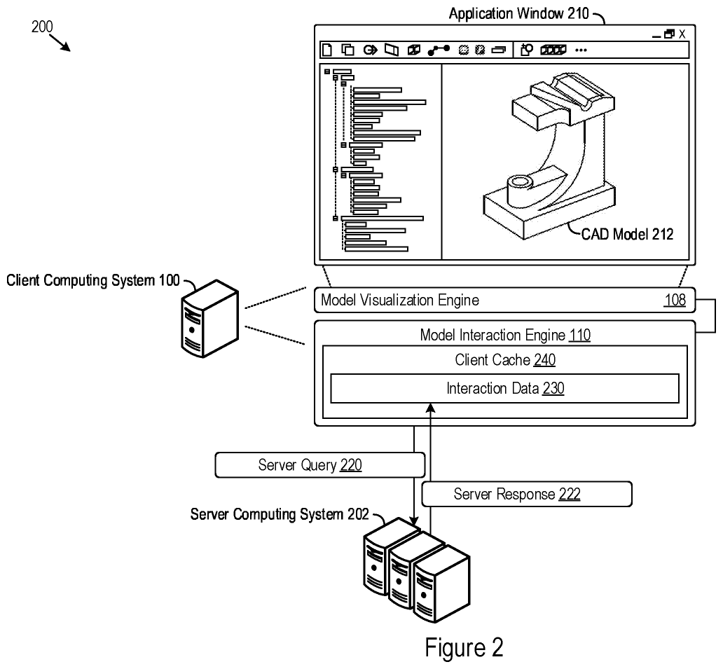

FIG. 2 shows an example architecture 200 that supports selective loading of interaction data for visualized elements of a CAD model. The example architecture 200 shown in FIG. 2 includes a client computing system 100 and a server computing system 202. The client computing system 100 and server computing system 202 may together support a client-server (e.g., SaaS) based implementation of a CAD application, in which CAD software can be centrally hosted on a CAD application server (such as the server computing system 202) and accessed via thin clients implemented by client devices (e.g., the client computing system 100). To support such features, the client computing system 100 and server computing system 202 may be communicatively linked, e.g., via the Internet, local or wide area networks, etc.

The client computing system 100 as shown in FIG. 2 includes the model visualization engine 108 and the model interaction engine 110. The model visualization engine 108 may include any capability to support visualization of CAD models by the client computing system 100. In that regard, the model visualization engine 108 may access visualization data for a CAD model and display the CAD model (or given views of the CAD model) via thin clients of the client computing system 100. In the example shown in FIG. 2, the model visualization engine 108 provides a CAD application display through an application window 210 of a thin client, and example thin clients include web browsers, application portals, or light-weight client applications, or any other client that can interface with CAD software centrally hosted by the server computing system 202. As shown in FIG. 2, the model visualization engine 108 may visualize the CAD model 212 in the application window 210, which may then support user interaction to access, modify, test, or otherwise configure the CAD model 212.

The model visualization engine 108 may access visualization data for the CAD model 212 from the server computing system 202. As CAD models continue to increase in complexity, visualization data may likewise increase in size and complexity. As such, the model visualization engine 108 may compress, reduce, or otherwise limit accessed visualization data for the CAD model 212 only to what is necessary to display the CAD model 212 in the application window 210. Put another way, visualization data of the CAD model 212 accessed by the model visualization engine 108 may support display of the CAD model 212, but may lack any data to support given user interactions with visualized elements (e.g., CAD faces) of the CAD model 212. Example forms of visualization data include CAD face data or mesh data to construct a rendering of the CAD model 212 to display in the application window 210.

To support CAD model interaction, the model interaction engine 110 may selectively load interaction data for some, but not all, of the visualized elements of the CAD model 212 displayed in the application window 210. As noted herein, interaction data may include CAD model data (aside from visualization data) that supports any user interaction with the CAD model 212 or selected portions thereof. Example of interaction data include edge data (e.g., when a CAD model can be visualized through CAD face data alone, without edge data), snap point data, tangent chaining data, feature selection data, geometry analytics data of the CAD model 212, and more. Such interaction data may support CAD model interactions in the form of selection, dragging, context menus, heads up displays, and so on.

To selectively load interaction data, the model interaction engine 110 may identify selected CAD model elements (e.g., CAD faces, assembly components, or any other delineated portion of a CAD model) as candidate CAD model elements that a user may potentially interact with, doing so by applying any number of interaction criteria to make such determinations. The determined set of candidate elements may comprise a set of candidate CAD model elements visualized in the application window 210 for which the model interaction engine 110 may selectively load interaction data for.

Many of the selective loading features described herein are presented using candidate CAD faces as example candidate CAD model elements the model interaction engine 110 may determine or identify. A CAD face may refer to any delineated surface in the CAD model, and may be visualized with multiple facets (e.g., as a surface mesh). However, any type of candidate CAD model element and corresponding interaction criteria contemplated in the scope of this disclosure. For instance, the model interaction engine 110 may identify candidate CAD components (e.g., comprised of multiple CAD faces or other CAD sub-parts) that are part of a larger CAD assembly. The interaction criteria and selective interaction data loading features may be consistently applied for candidate CAD components and/or any other type of CAD model elements that the model interaction engine 110 may determine as candidates for user interaction.

Interaction criteria may be set by the model interaction engine 110 with a goal of identifying realistic or likely candidates of the CAD model 212 that a user may interact with. Explained in another way, applied interaction criteria may filter non-realistic or non-likely CAD model elements of user interaction, and do so as controlled through specific parameters of the interaction criteria. In effect, applied interaction criteria may allow the model interaction engine 110 to load interaction data for a selected subset of visualized elements of the CAD model 212, thereby increasing efficiency and reducing network latencies as compared to simplistically loading interaction data for all visualized elements of the CAD model 212. Moreover, interaction criteria may allow the model interaction engine 110 to pre-load interaction data prior to actual user interaction, which may reduce or eliminate network latencies and application lag that may be prevalent for interaction data queries executed at or after actual user interaction.

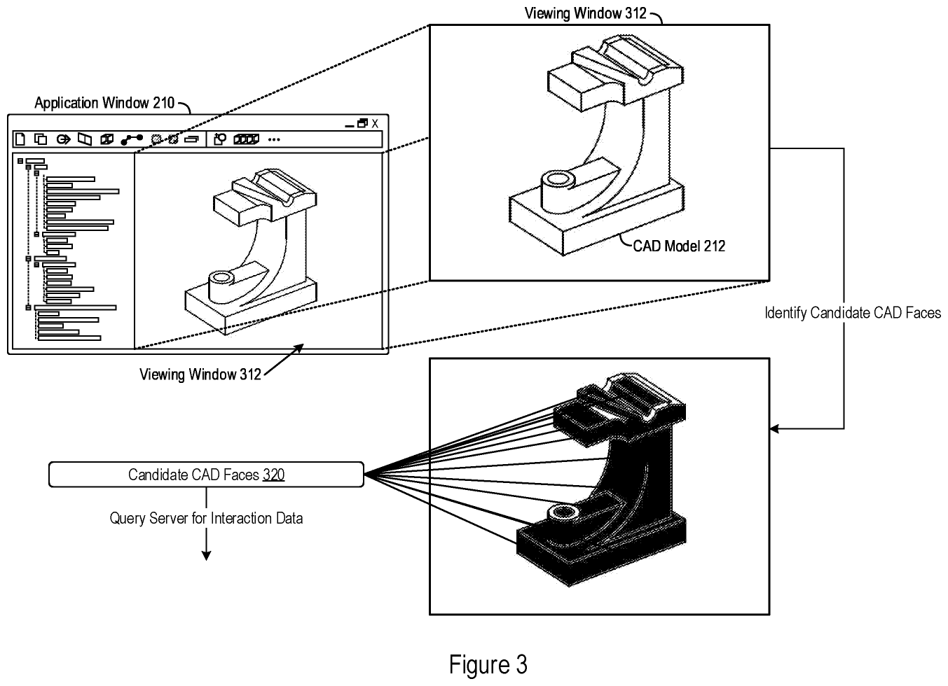

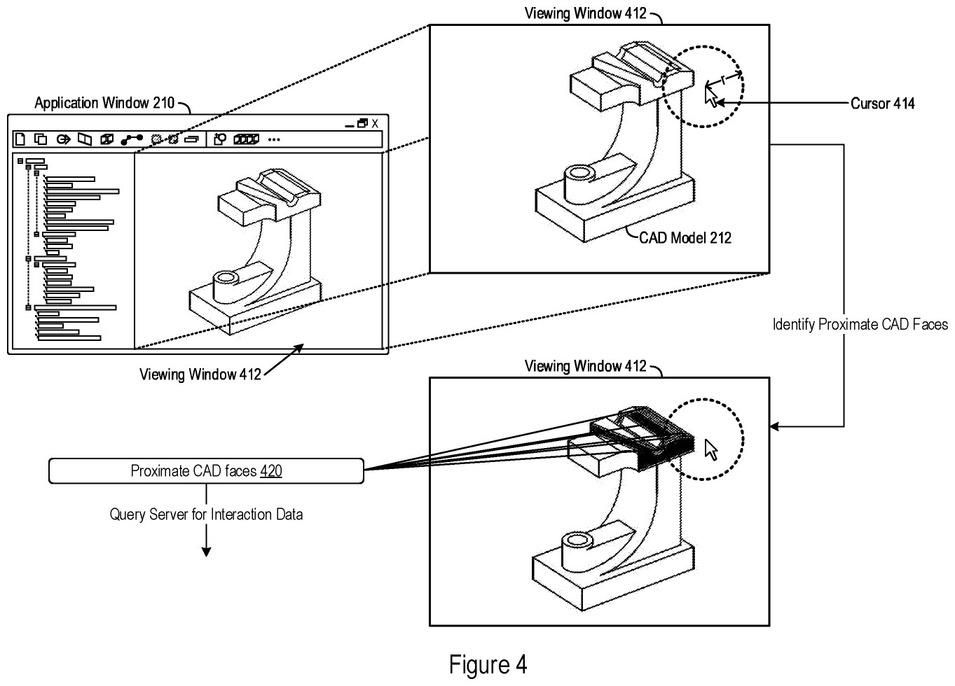

Examples of interaction criteria that the model interaction engine 110 may apply are described in greater detail below in connection with FIGS. 3 and 4.

By applying interaction criteria, the model interaction engine 110 may determine a set of candidate CAD model elements (e.g., CAD faces) for a visualized CAD model 212. Referring again to FIG. 2, the model interaction engine 110 may query the server computing system 202 for interaction data specifically for the determined candidate CAD faces. In FIG. 2, the model interaction engine 110 constructs and sends the server query 220 to the server computing system 202. The server query 220 may request interaction data for the candidate CAD faces of the CAD model 212 as determined by the model interaction engine 110, but not for other non-candidate CAD faces of the CAD model 212. The server computing system 202 may respond to the server query 220 with the server response 222, which may include the requested interaction data for the determined candidate CAD faces of the CAD model 212.

The interaction data for determined candidate CAD faces of the CAD model 212 is shown in FIG. 2 as the interaction data 230, which the model interaction engine 110 may store locally in the client computing system 100. For instance, the model interaction engine 110 may store interaction data 230 in a client cache 240, which the model interaction engine 110 may itself implement or which may be otherwise locally implemented by the client computing system 100. Cached interaction data may be locally stored on the client computing system 100 and readily available for subsequent user interactions with the CAD model 212. Thus, the model interaction engine 110 may selectively load the interaction data 230 (e.g., into the client cache 240) for some, but not all, of the displayed elements of a CAD model.

Various examples of how the model interaction engine 110 may determine candidate CAD faces for which to selectively load interaction data are presented next in connection with FIGS. 3 and 4.

FIG. 3 shows an example of candidate CAD faces that the model interaction engine 110 may identify to support selective loading of interaction data. In FIG. 3, the application window 210 described in FIG. 2 is again shown, which includes a viewing window 312 as labeled in FIG. 3. The viewing window 312 may refer to a selected subsection of the application window 210 (e.g., a specific portion of a web browser), and may be any display portion specifically designated by a CAD application to display the CAD model 212. In that regard, the viewing window 312 may be separate from other components of a user interface (“UI”) for a CAD application or application window 210, e.g., separate from web address bars, command ribbons, operation libraries, formatting bars, or other UI components of a CAD application. Thus, the viewing window 312 may refer to an application-specific portion of a CAD application UI to visualize and display a CAD model.

In some implementations, the model interaction engine 110 determines candidate CAD faces to selectively load interaction data based on attributes of the viewing window 312. In particular, the model interaction engine 110 may apply a size criterion with respect to the viewing window 312 to determine candidate CAD faces to selectively query interaction data for. Such a size criterion may be satisfied, for example, when the size of a given CAD face exceeds a threshold percentage (e.g., 10%) of a size of the viewing window 312, e.g., total size, width, height, etc. Through application of such a size criterion, the model interaction engine 110 may eliminate (relatively) smaller CAD faces as interaction candidates, and the size criterion may be configured to apply a threshold percentage of a size of the viewing window 312 so as to identify non-candidate CAD faces which are smaller in size, and thus less likely (or incapable) of user interaction for a presently visualized view of the CAD model 212.

To apply such a size criterion, the model interaction engine 110 may determine a size of the viewing window 312 and compute a size of each CAD face of the CAD model 212 visualized in the viewing window 312. In that regard, such a size criterion may be referred to as globally-applied size criterion as it may be applied to any CAD face as displayed in the viewing window 312 (and in doing so, the model interaction engine 110 may filter, from candidate determination, any CAD model element of the CAD model 212 that is not displayed in the viewing window 312). Computed sizes may be in the form of 2-dimensional (“2D”) areas, e.g., as measured in a 2D pixel space, perimeters, height or width values, diagonal values (e.g., of bounding boxes surrounding a CAD model element), or according to any other size parameter of the viewing window 312 and CAD model elements of a CAD model. Computation of CAD face sizes may be done specifically for a current view of the CAD model 212 as displayed in the viewing window 312. The model interaction engine 110 may identify, as a candidate CAD face, any given CAD face of the CAD model 212 with a size that exceeds at least a threshold percentage of the size of the viewing window 312.

As an illustrative example through FIG. 3, the model interaction engine 110 may determine the viewing window 312 as having dimensions of 800 pixels×600 pixels, and thus having a size of 480,000 pixels. In applying a size criterion with an example threshold percentage of 4%, the model interaction engine 110 may identify candidate CAD faces as any CAD face with a size greater than 19,200 pixels in the displayed view of the CAD model 212 in the viewing window 312. As another example implementation, the size criterion may be applied to diagonal values of bounding boxes surrounding CAD faces as compared to a threshold percentage of a diagonal value of the viewing window 312. In the example shown in FIG. 3, the model interaction engine 110 may apply a size criterion to determine a set of candidate CAD faces labeled as candidate CAD faces 320 for the CAD model 212 displayed in the viewing window 312 (individual CAD faces patterned in black in FIG. 3). Then, the model interaction engine 110 may query a CAD application server for interaction data of the candidate CAD faces 320 determined for the CAD model 212 displayed in the viewing window 312.

In some implementations, the model interaction engine 110 may re-determine candidate CAD faces to selectively query interaction data for at triggering events. A triggering event may refer to any event determined by the model interaction engine 110 upon which the model interaction engine 110 selectively queries a CAD application server for interaction data. For instance, the model interaction engine 110 may identify size-based triggering events, which may refer to any event that changes the size of the viewing window 312 or the size of a threshold number of visualized elements of the CAD model 212 displayed in the viewing window 312.

Examples of size-based triggering events may include resizing of the viewing window 312, e.g., by maximizing the application window 210 or otherwise adjusting a CAD application UI to increase or reduce the size of the viewing window 312. Other examples include changing a camera view of the CAD model 212 in the viewing window 312, whether by rotating a view of the CAD model 212 (thereby changing the 2D area of the CAD faces displayed in the viewing window 312, visualizing CAD faces of the CAD model 212 not previously displayed, removing of CAD faces that were visualized prior to the camera change, etc.) or by adjusting the zoom of the camera (either zooming in, which may increase the 2D area of displayed CAD faces, or by zooming out, which may decrease the area of displayed CAD faces).

Upon identification of any combination of the above-described triggering events, the model interaction engine 110 may re-determine candidate CAD faces for the CAD model 212 as displayed in the viewing window 312 and selectively load interaction data for the redetermined candidate CAD faces accordingly. The model interaction engine 110 may re-determine candidate CAD faces in a consistent manner as described above, globally applying a size criterion to an updated view of the CAD model 212 as changed by the triggering event.

As other examples of interaction criteria and triggering events, the model interaction engine 110 may determine candidate CAD faces based on proximity to cursor positions, described in greater detail next in connection with FIG. 4.

FIG. 4 shows an example of proximate CAD faces that the model interaction engine 110 may identify to support selective loading of interaction data. Proximate CAD faces may refer to CAD faces that the model interaction engine 110 may selectively load interaction data for based on an applied proximity criterion, e.g., with respect to a cursor or other UI-based interaction mechanism. In that regard, proximate CAD faces may also be considered candidate CAD faces that the model interaction engine 110 may query a CAD application server for interaction data, but may be identified based on a proximity distance as opposed to size relative to a viewing window. That is, proximate CAD faces may be identified as potential interaction candidates based on a mouse cursor (or other UI-based interaction mechanism) position. The model interaction engine 110 may determine the closer in distance a visualized CAD model element is to the mouse cursor, the more likely a user may interact with a particular CAD face or visualized CAD model element.

To illustrate, FIG. 4 shows the application window 210 with a viewing window 412. The viewing window 412 shown in FIG. 4 includes a cursor 414, by which a user may interact with (e.g., select or drag) visualized elements of the CAD model 212. To determine proximate CAD faces, the model interaction engine 110 may apply a proximity criterion that is satisfied when CAD faces of the CAD model 212 are within a proximity distance from the cursor 414. In FIG. 4, the proximity distance is specified as a pixel distance and illustrated through the radius cr′ and the dotted circle that encompasses the tip of the cursor 414. Any CAD face in the CAD model 212 within a distance of cr′ pixels from the cursor 414 (e.g., cursor tip) may be identified as a proximate CAD face by the model interaction engine 110.

The model interaction engine 110 may configure the proximity distance of a proximity criterion in various ways, for example as an explicit distance value (e.g., 50 pixel threshold distance), as a percentage of a dimension of the viewing window 412 (e.g., 5% of the width dimension of the viewing window 412), or in various other ways. As other examples, a proximity criterion applied by the model interaction engine 110 may applied through a bounding box surrounding the cursor 414 (e.g., a 100 pixel×100 pixel bounding box with the tip of the cursor 414 at the center of the bounding box), or in any other form that provides a distance-based criterion by which the model interaction engine 110 can identify proximate CAD faces displayed in the application window 412.

In FIG. 4, the model interaction engine 110 identifies the proximate CAD faces 420 for the view of the CAD model 212 displayed in the viewing window 412, and doing so based on the position of the cursor 414. The model interaction engine 110 may then query a CAD application server for interaction data of the proximate CAD faces 420 to support subsequent user interactions with any of the identified proximate CAD faces 420. As the cursor 414 changes positions, the model interaction engine 110 may continue to identify proximate CAD faces to selectively query a CAD application server for corresponding interaction data.

In some implementations, the model interaction engine 110 identifies some, but not all, CAD faces within a proximity distance from the cursor 414 as the proximate CAD faces 420 for which to selectively load interaction data. In such cases, the model interaction engine 110 may apply a secondary size criterion to CAD faces within the proximity distance. In a similar manner as discussed above for size criterion applied globally to a present view of the CAD model 212, the secondary size criterion may filter CAD faces that are too small to be likely interaction candidates, even when positioned less than the proximity distance from the cursor 414. However, the secondary size criterion may be referred as a locally-applied size criterion in that the model interaction engine 110 may apply the secondary size criterion only to CAD faces positioned within a proximity distance from the cursor 414.

The secondary size criterion may be applied in addition to the globally-applied size criterion used to determine candidate CAD faces based on a size of the viewing window (e.g., as described above for FIG. 3). In some implementations, the secondary size criterion may specify a looser size threshold than the size criterion applied generally (e.g., globally) to the CAD model 212. Put another way, a greater number of CAD faces of the CAD model 212 may satisfy the secondary size criterion (if applied globally) than the size criterion used to determine the candidate CAD faces of the CAD model 212 as described in FIG. 3.

To illustrate, the secondary size criterion may be satisfied when a given CAD face has a size that is at least 2% of the size of the viewing window 412, whereas a globally-applied size criterion may require at least a 4% size of the viewing window 412. As such, the model interaction engine 110 may identify some proximate CAD faces in the CAD model based on proximity to the cursor 414 that were not or would not have been identified as candidate CAD faces based on the size criterion globally applied to the CAD model 212 (e.g., identified as the candidate CAD faces 320 in FIG. 3), but are now identified as proximate CAD faces by being within the proximity distance from the cursor 414 and satisfying the secondary (looser) size criterion.

As described herein, the model interaction engine 110 may identify candidate CAD faces (which may include proximate CAD faces) to selectively load interaction data, including through application of size-based interaction criteria, proximity-based interaction criteria, or combinations of both.

In some implementations, the model interaction engine 110 queries a CAD application server for a specific subset of interaction data for identified candidate CAD faces, doing so based on a specific application context or mode in which a CAD application operates. A CAD application may provide multiple interaction capabilities through various CAD interaction operations, such as selection operations, dragging operations, geometric analyses operations, and many more. The model interaction engine 110 may query for selected interaction data of determined candidate CAD faces based on a current CAD interaction operation being used to interact with a CAD model.

As illustrative examples, the model interaction engine 110 may query a CAD application server for interaction data in the form of snap point data when the current CAD interaction operation used by a user for a CAD model is a selection operation. When the current interaction operation is instead a geometry analysis operation, the model interaction engine 110 may instead query the CAD application server for geometry analytics data (and not snap point data). By doing so, the model interaction engine 110 may limit queried interaction data to apply specifically to the CAD interaction operation presently selected/used for a CAD application. Querying for selected forms of interaction data may reduce overall amount of queried interaction data, and thus reduce the consumed network bandwidth required to retrieve interaction data and improve the efficiency of user interaction with CAD models in client-server based CAD application implementations.

To support querying of selected interaction data differing based on current CAD interaction operations, the model interaction engine 110 may differentiate caching of interaction data based on CAD interaction operation. For instance, the model interaction engine 110 may separate a client cache (e.g., the client cache 240 shown in FIG. 2) into multiple different memories, whether as physically separate or logically separate. Each separated memory may cache interaction data for different CAD interaction operations or different types of interaction data (e.g., a first cache for storing snap point interaction data, a second cache for storing geometry analytics interaction data, etc.). Based on the current CAD interaction operation and constructed query to the CAD application server for identified candidate CAD faces, the model interaction engine 110 may cache received interaction data in a corresponding one of the multiple memories.

Additionally or alternatively, the model interaction engine 110 may employ any number of cache indexing and eviction techniques to maintain local caches of client computing systems used to store interaction data. For an identified set of candidate CAD faces (which may include proximate CAD faces), the model interaction engine 110 may first filter any candidate CAD faces with interaction data already indexed (and thus stored) in a client cache, including doing so on a CAD interaction operation-specific basis. To illustrate, for an identified set of proximate CAD faces when the current CAD interaction operation for the CAD application is a selection operation, the model interaction engine 110 may filter, from server queries, any of the proximate CAD faces with snap point data already stored in a local cache designated for storing snap point interaction data. In a similar manner, the model interaction engine 110 may lookup entries in other interaction data caches to filter interaction data queries to a CAD application server. By doing so, the model interaction engine 110 may reduce or eliminate redundant queries for interaction data already loaded in the client cache from prior interaction data queries to the CAD application server.

Thus, the model interaction engine 110 may support selective loading of interaction data for selected portions of displayed CAD models.

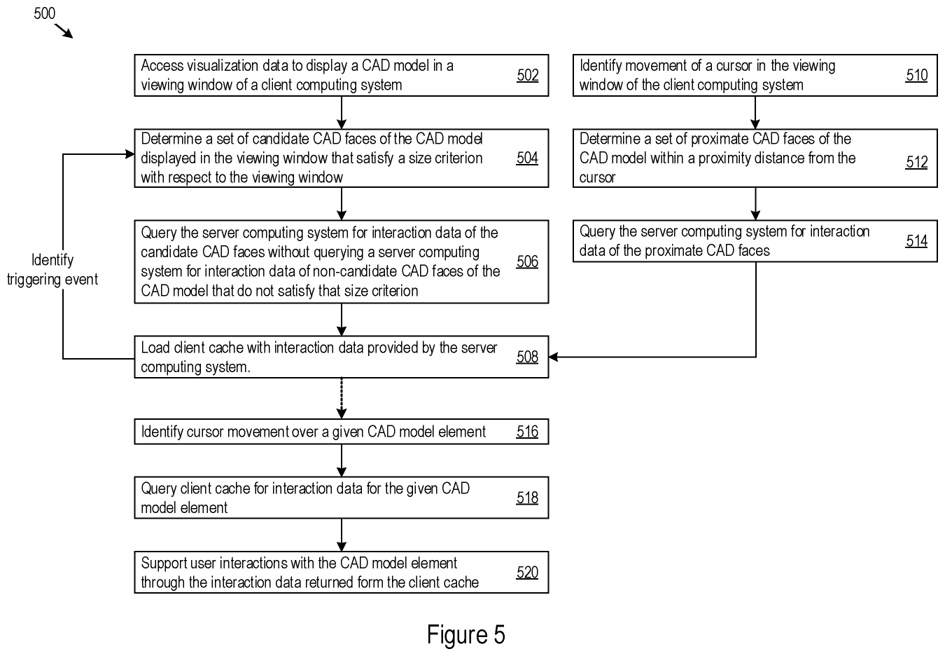

FIG. 5 shows an example of logic 500 that a system may implement to support selective loading of interaction data for visualized elements of a CAD model. For example, the client computing system 100 may implement the logic 500 as hardware, executable instructions stored on a machine-readable medium, or as a combination of both. The client computing system 100 may implement the logic 500 via the model visualization engine 108 and the model interaction engine 110, through which the client computing system 100 may perform or execute the logic 500 as a method to support selective interaction data loading. The following description of the logic 500 is provided using the model visualization engine 108 and the model interaction engine 110 as examples. However, various other implementation options by systems are possible.

In implementing the logic 500, the model visualization engine 108 may access visualization data to display a CAD model in a client computing system (502). The model visualization engine 108 may further use the access visualization data to display a view of the CAD model in the viewing window, e.g., as through a 3D-to-2D mapping for an initial or current camera view for displaying the CAD model.

In implementing the logic 500, the model interaction engine 110 may determine a set of candidate CAD faces of the CAD model displayed in the viewing window that satisfy a size criterion with respect to the viewing window (504). In that regard, the model interaction engine 110 may globally apply the size criterion to each of the CAD faces displayed in the current camera view of the CAD model. As noted herein, such a globally-applied size criterion may be satisfied when a size of a given CAD face exceeds a threshold percentage of a size of the viewing window.

Then, the model interaction engine 110 may query a server computing system for interaction data of the candidate CAD faces, and do so without querying the server computing system for interaction data of non-candidate CAD faces of the CAD model that do not satisfy that size criterion (506). In such a manner, the model interaction engine 110 may selectively query a CAD application server for some, but not all, of the visualized elements of a CAD model in a current camera view. Upon receiving a server response to the query, the model interaction engine 110 may load a client cache with the interaction data provided by the server computing system (508).

As such, the model interaction engine 110 may selectively load interaction data for a current view of a CAD model. Responsive to identification of a triggering event, the model interaction engine 110 may redetermine candidate CAD faces based on a change in the viewing window, change in the displayed CAD model, or movement of mouse cursors or other UI interaction mechanisms supported by a CAD application.

For instance, the model interaction engine 110 may identify size-based triggering events based on changes in camera view, camera zoom, or a resizing of the viewing window. Responsive to identifying any of these triggering events, the model interaction engine 110 may determine, for the updated camera view or resized viewing window, a redetermined set of candidate CAD faces that satisfy the size criterion with respect to the (possibly resized) viewing window (504), send another query to the server computing system for the redetermined set of candidate CAD faces (506), and load the client cache with the provided interaction data (508). In some instances, the model interaction engine 110 may filter the query such that already-cached interaction data for the redetermined candidate CAD faces (e.g., loaded from a previous query) is not re-loaded into the client cache.

Other examples of triggering events may be proximity based. In such examples, the model interaction engine 110 may track movement of a mouse cursor (or other UI interaction mechanism). To illustrate, the model interaction engine 110 may identify movement of a cursor in the viewing window of the client computing system (510) and determine a set of proximate CAD faces of the CAD model within a proximity distance from the cursor (512). In some implementations, the model interaction engine 110 may apply a secondary (or local) size criterion for CAD faces within the proximity distance in order to determine the proximate CAD faces. Then, the model interaction engine 110 may query the server computing system for interaction data of the proximate CAD faces (514), which may also include filtering the query to account for already-cached interaction data.

In the various ways described above, the model interaction engine 110 may populate a client cache with interaction data for selected visualized elements of a CAD model, including accounting for different triggering events that may occur through active use of a CAD application by a user. Note that the model interaction engine 110 may support selective loading of interaction data into a client cache prior to user interaction with a given CAD face or visualized CAD model elements. Triggering events may be specifically identified by the model interaction engine 110 prior to user interaction (via selection, mouseover, dragging, etc.) of CAD model elements. Instead, the model interaction engine 110 may determine candidate CAD faces as the camera view changes or upon mouse movement proximate (but not yet at) CAD model elements, and querying for interaction data prior to actual user interaction.

By the time a user interacts with a given CAD model element via the CAD application, the model interaction engine 110 may already have loaded interaction data for the given CAD model element into a local client cache, which may thus support interactions with reduced latency and network consumption, while improving application performance.

To illustrate through FIG. 5, the model interaction engine 110 may identify a user interaction in a CAD application through identifying cursor movement over a given CAD model element (516), such as an edge in the displayed CAD model. In response, the model interaction engine 110 may query a locally-implemented client cache for interaction data of the given CAD model element (518). As the given CAD model element may have been previously determined as a candidate CAD face, interaction data for the given CAD model element may have been selectively loaded into the client cache prior to the identified cursor movement over the given CAD model element. Accordingly, the model interaction engine 110 can retrieve the locally cached interaction data and support user interactions with the given CAD model element through the interaction data returned from the client cache (520).

The logic 500 shown in FIG. 5 provides but one example by which a client computing system 100 may support selective loading of interaction data for visualized elements of a CAD model. Additional or alternative steps in the logic 500 are contemplated herein, including according to any features described for the model visualization engine 108, model interaction engine 110, or any combinations thereof.

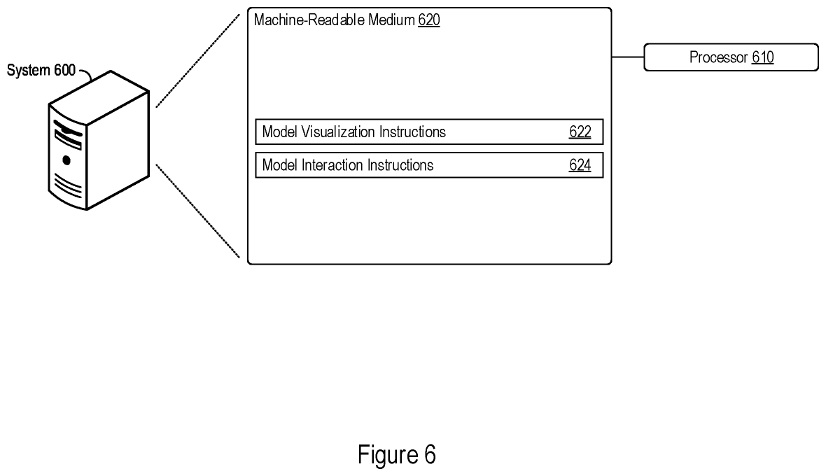

FIG. 6 shows an example of a system 600 that supports selective loading of interaction data for visualized elements of a CAD model. The system 600 may include a processor 610, which may take the form of a single or multiple processors. The processor(s) 610 may include a central processing unit (CPU), microprocessor, or any hardware device suitable for executing instructions stored on a machine-readable medium. The system 600 may include a machine-readable medium 620. The machine-readable medium 620 may take the form of any non-transitory electronic, magnetic, optical, or other physical storage device that stores executable instructions, such as the model visualization instructions 622 and the model interaction instructions 624 shown in FIG. 6. As such, the machine-readable medium 620 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The system 600 may execute instructions stored on the machine-readable medium 620 through the processor 610. Executing the instructions (e.g., the model visualization instructions 622 and/or the model interaction instructions 624) may cause the system 600 to perform any of the selective interaction data loading features described herein, including according to any of the features with respect to the model visualization engine 108, the model interaction engine 110, or a combination of both.

For example, execution of the model visualization instructions 622 by the processor 610 may cause the system 600 to access, from a server computing system remote to the system 600, visualization data to display a CAD model in a viewing window of the system 600. Execution of the model interaction instructions 624 by the processor 610 may cause the system 600 to determine a set of candidate CAD model elements of a CAD model displayed in a viewing window of the client computing system, including by determining the candidate CAD model elements satisfy a size criterion with respect to the viewing window and query a server computing system for interaction data of the candidate CAD model elements without querying the server computing system for interaction data of non-candidate CAD model elements of the CAD model that do not satisfy that size criterion,

Any additional or alternative features as described herein may be implemented via the model visualization instructions 622, model interaction instructions 624, or a combination of both.

The systems, methods, devices, and logic described above, including the model visualization engine 108 and the model interaction engine 110, may be implemented in many different ways in many different combinations of hardware, logic, circuitry, and executable instructions stored on a machine-readable medium. For example, the model visualization engine 108, the model interaction engine 110, or combinations thereof, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the model visualization engine 108, the model interaction engine 110, or combinations thereof.

The processing capability of the systems, devices, and engines described herein, including the model visualization engine 108 and the model interaction engine 110, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
by a client computing system:
accessing, from a server computing system, visualization data to display a computer-aided design (CAD) model in a viewing window of the client computing system;
determining a set of candidate CAD faces of the CAD model displayed in the viewing window that satisfy a size criterion with respect to the viewing window; and
querying the server computing system for interaction data of the candidate CAD faces without querying the server computing system for interaction data of non-candidate CAD faces of the CAD model that do not satisfy that size criterion,
wherein the interaction data comprises CAD model data that supports user interaction with the candidate CAD faces of the CAD model.

2. The method of claim 1, comprising querying the server computing system for selected interaction data of the candidate CAD faces based on a current CAD interaction operation for the CAD model.

3. The method of claim 1, wherein the size criterion is satisfied when a size of a given CAD face exceeds a threshold percentage of a size of the viewing window.

4. The method of claim 1, further comprising:
identifying movement of a cursor in the viewing window of the client computing system;
determining a set of proximate CAD faces of the CAD model within a proximity distance from the cursor; and
further querying the server computing system for interaction data of the proximate CAD faces.

5. The method of claim 4, wherein determining the set of proximate CAD faces of the CAD model comprises:
identifying CAD faces of the CAD model within the proximity distance from the cursor that also satisfy a secondary size criterion, wherein more CAD faces of the CAD model satisfy the secondary size criterion than the size criterion used to determine the candidate CAD faces of the CAD model.

6. The method of claim 1, wherein the interaction data comprises edge data, snap point data, tangent chaining data, feature selection data, or geometry analytics data of the CAD model.

7. The method of claim 1, wherein the viewing window is a subsection of an application window.

8. A client computing system comprising:
a model visualization engine configured to access, from a server computing system remote to the client computing system, visualization data to display a computer-aided design (CAD) model in a viewing window of the client computing system; and
a model interaction engine configured to query the server computing system for interaction data of a selected portion of the CAD model, but not other portions of the CAD model, wherein the interaction data comprises CAD model data that supports user interaction with the selected portion of the CAD model.

9. The system of claim 8, wherein the model interaction engine is configured to query the server computing system for selected interaction data of the selected portion of the CAD model based on a current CAD interaction operation for the CAD model.

10. The system of claim 8, wherein the model interaction engine is configured to query the server computing system for the interaction data of the selected portion of the CAD model by:
determining, as the selected portion, a set of candidate CAD model elements of the CAD model displayed in the viewing window that satisfy a size criterion with respect to the viewing window; and
querying the server computing system for interaction data of the candidate CAD model elements without querying the server computing system for interaction data of non-candidate CAD model elements of the CAD model that do not satisfy that size criterion.

11. The system of claim 10, wherein the size criterion is satisfied when a size of a given CAD model element exceeds a threshold percentage of a size of the viewing window.

12. The system of claim 10, wherein the model interaction engine is further configured to:
identify movement of a cursor in the viewing window of the client computing system;
determine a set of proximate CAD model elements of the CAD model within a proximity distance from the cursor; and
further query the server computing system for interaction data of the proximate CAD model elements.

13. The system of claim 12, wherein the model interaction engine is configured to determine the set of proximate CAD model elements by:
identifying CAD model elements of the CAD model within the proximity distance from the cursor that also satisfy a secondary size criterion, wherein more CAD model elements of the CAD model satisfy the secondary size criterion than the size criterion used to determine the candidate CAD model elements of the CAD model.

14. The system of claim 8, wherein the interaction data comprises edge data, snap point data, tangent chaining data, feature selection data, or geometry analytics data of the CAD model.

15. A non-transitory machine-readable medium comprising instructions that, when executed by a processor, cause a client computing system to:
determine a set of candidate CAD model elements of a CAD model displayed in a viewing window of the client computing system, including by determining the candidate CAD model elements satisfy a size criterion with respect to the viewing window; and
query a server computing system for interaction data of the candidate CAD model elements without querying the server computing system for interaction data of non-candidate CAD model elements of the CAD model that do not satisfy that size criterion,
wherein the interaction data comprises CAD model data that supports user interaction with the candidate CAD model elements of the CAD model.

16. The non-transitory machine-readable medium of claim 15, wherein the instructions cause the client computing system to query the server computing system for selected interaction data of the selected portion of the CAD model based on a current CAD interaction operation for the CAD model.

17. The non-transitory machine-readable medium of claim 15, wherein the instructions cause the client computing system to query the server computing system for the interaction data of the selected portion of the CAD model by:
determining, as the selected portion, a set of candidate CAD model elements of the CAD model displayed in the viewing window that satisfy a size criterion with respect to the viewing window; and
querying the server computing system for interaction data of the candidate CAD model elements without querying the server computing system for interaction data of non-candidate CAD model elements of the CAD model that do not satisfy that size criterion.

18. The non-transitory machine-readable medium of claim 17, wherein the size criterion is satisfied when a size of a given CAD model element exceeds a threshold percentage of a size of the viewing window.

19. The non-transitory machine-readable medium of claim 17, wherein the instructions further cause the client computing system to:
identify movement of a cursor in the viewing window of the client computing system;
determine a set of proximate CAD model elements of the CAD model within a proximity distance from the cursor; and
further query the server computing system for interaction data of the proximate CAD model elements.

20. The non-transitory machine-readable medium of claim 19, wherein the instructions cause the client computing system to determine the set of proximate CAD model elements by:
identifying CAD model elements of the CAD model within the proximity distance from the cursor that also satisfy a secondary size criterion, wherein more CAD model elements of the CAD model satisfy the secondary size criterion than the size criterion used to determine the candidate CAD model elements of the CAD model.
